(19) United States
(12) Patent Application Publication
(10) Pub. No.: US 2002/0152869 A1
(43) Pub. Date: Oct. 24, 2002

(54) Cutter set for heat shrink film sleeve labeling machine

(76) Inventor: Fu-Chuan Huang, Chia-I Hsien (TW)

Correspondence Address: DOUGHERTY & TROXELL, SUITE 1404, 5205 LEESBURG PIKE, FALLS CHURCH, VA, 22041, US

(21) Appl. No.: 09/838,296

(22) Filed: Apr. 20, 2001

(51) Int. Cl. B26D 3/16

(52) U.S. Cl. 83/595; 83/596; 83/663

(57) ABSTRACT

An improved cutter set for heat shrink film sleeve labeling machine mainly includes a cutter adjustment block which has a plurality of screw bores formed at the bottom side thereof and two opposite troughs formed at a lower section in a stepwise manner for fastening respectively a cutter therein. Each cutter set has two sets of cutter thereby may shorten cutting displacement and perform cutting of the shrink film sleeve synchronously for producing an even and neat slit opening at a fast speed steadily. Changing of the cutter may be done conveniently and rapidly by loosening various screws.

### BACKGROUND OF THE INVENTION

This invention relates to an improved cutter set for heat shrink film sleeve labeling machine that enables the cutter be adjusted and replaced rapidly and conveniently for enhancing slitting operation efficiency.

The commonly used cutter set for heat shrink film sleeve labeling machine (as shown in FIG. 1) constitutes a central strut 9 surrounding by a stationary frame 90. The frame 90 has a plurality of cutter sets 91 disposed therein in an equally spaced fashion. Each cutter set 91 has an upper end engaged with a transmission disk 92. One cutter set 91′ engages with a transmission wheel 93 which is driven by a belt 94 for rotating the cutter set 91′ and consequently drives the transmission disk 92 rotating eccentrically thereby drives the cutter sets 91 rotating to perform slitting operation. The cutter sets 91 and 91′ (as shown in FIG. 2) includes a crank shaft 95, three sets of bearing 950, 951 and 952, a connection member 96, a cutter protractor plate 960, an anchor block 97, a cutter adjustment block 98, a cutter 980 and a fastening plate 99. When to adjust the cutter set 91, the screws P1, P2, and P3 must be loosened. It is a tedious process. Moreover, each cutter set 91 should be rotated 360 degree for doing the second time slitting operation. It is not efficient and results in waste of operation time

### SUMMARY OF THE INVENTION

It is therefore an object of this invention to provide an improved cutter set for heat shrink film sleeve labeling machine that has a cutter adjustment block with two stepwise opposite troughs and screw bores formed at the bottom side thereof for fastening cutters thereby to shorten cutting displacement and perform slitting operation at a fast and steady speed and is capable of changing cutter rapidly and conveniently.

### BRIEF DESCRIPTION OF THE DRAWINGS

The invention, as well as its many advantages, may be further understood by the following detailed description and drawings, in which:

FIG. 1 is a schematic sectional view of a conventional cutter set.

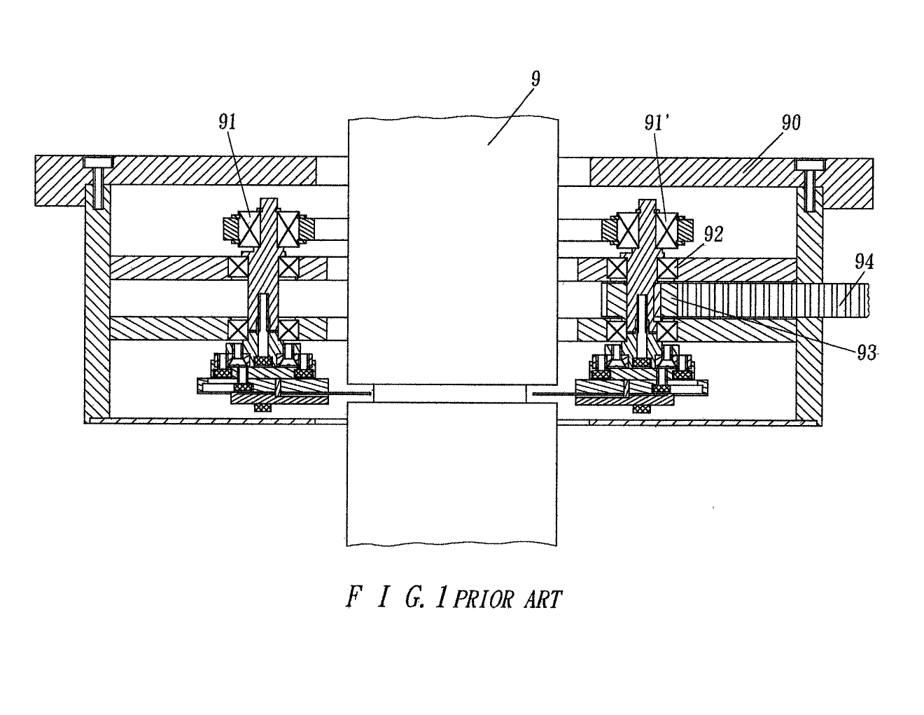

FIG. 2 is an exploded view of a conventional cutter set.

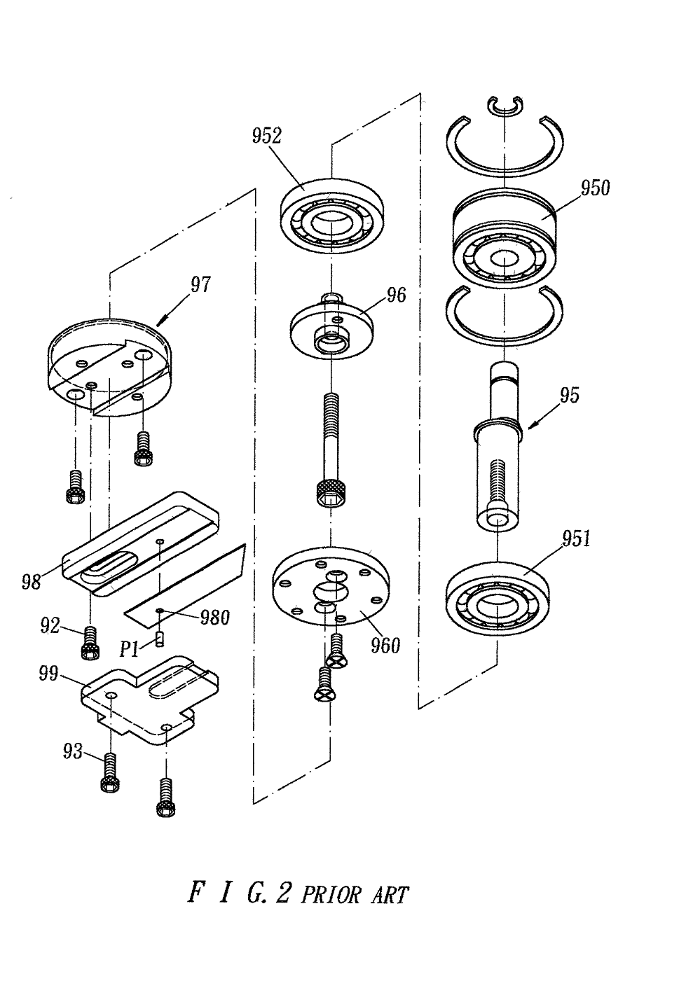

FIG. 3 is a schematic sectional view of this invention.

FIG. 4 is an exploded view of this invention.

FIG. 5 is an exploded view of this invention coupling with a transmission wheel.

FIG. 6 is a perspective view of this invention.

FIG. 7 is a perspective view of a cutter adjustment block of this invention.

FIG. 8 is a schematic view of the cutter sets driven by a transmission disk.

FIG. 9 is a schematic view of two neighboring cutters in motion.

### DETAILED DESCRIPTION OF THE PREFERRED EMBODIMENT

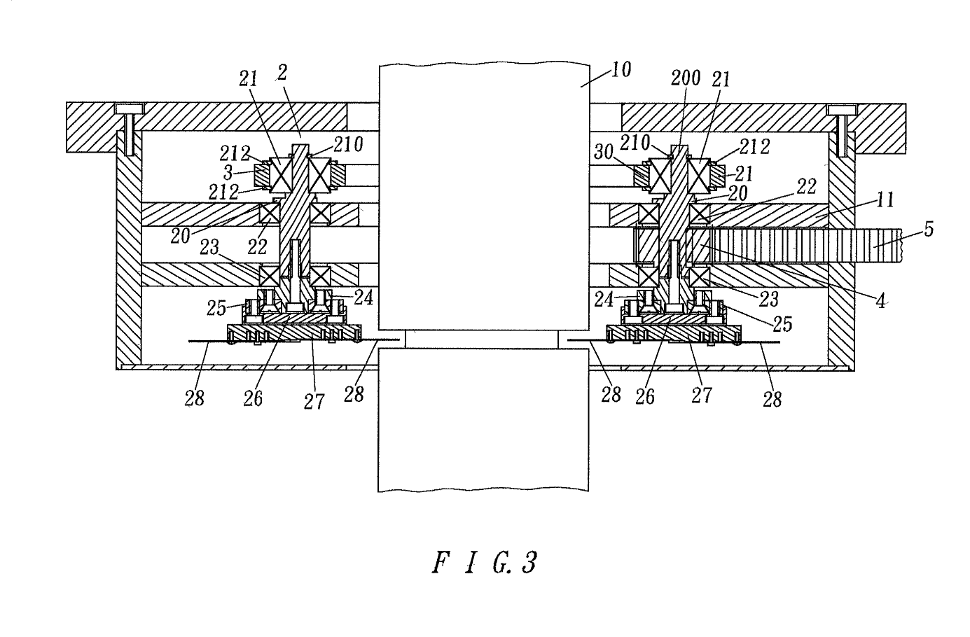

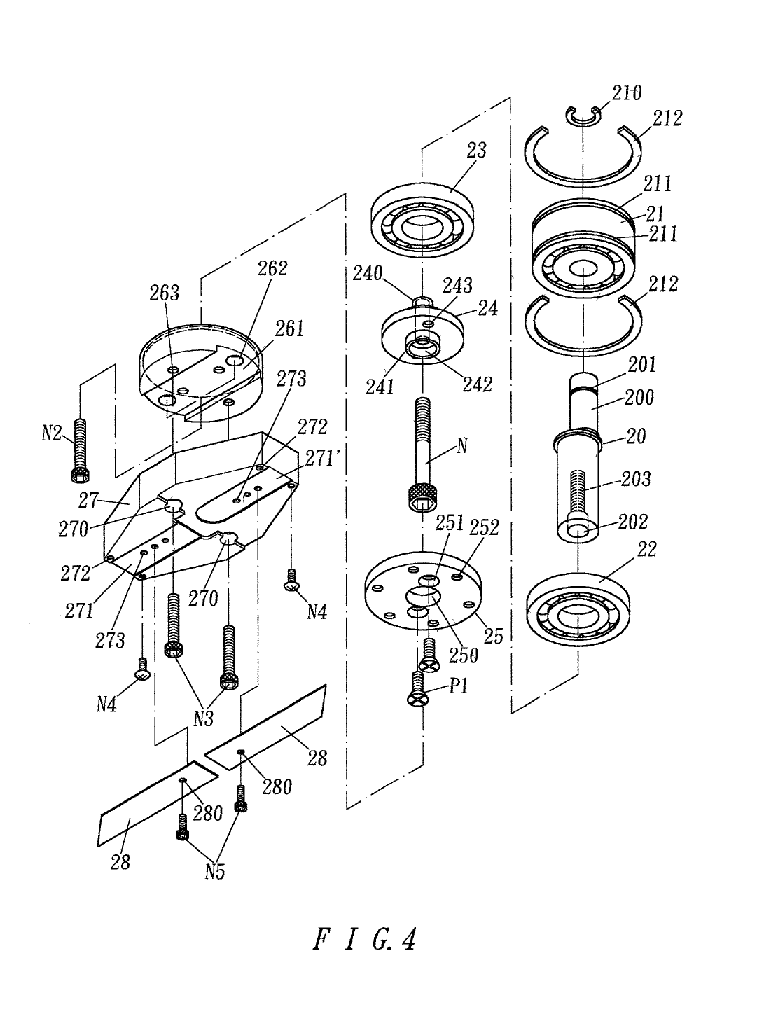

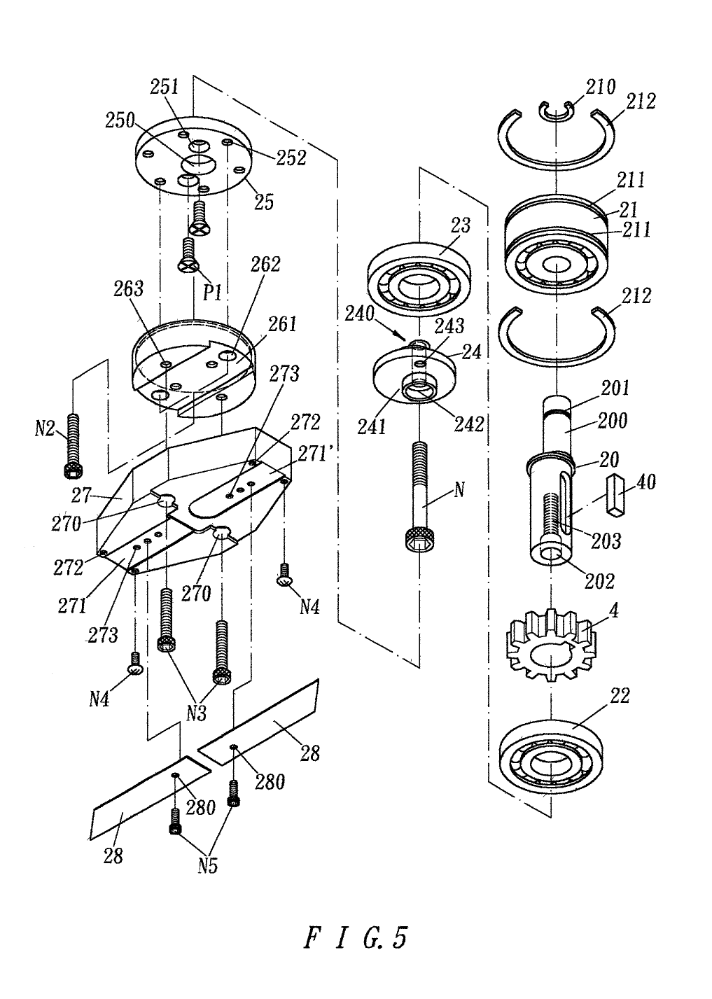

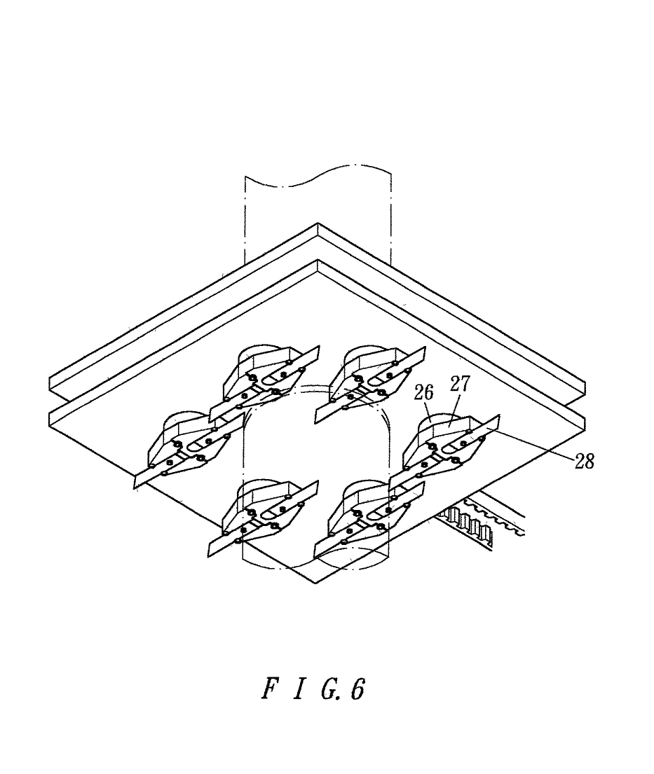

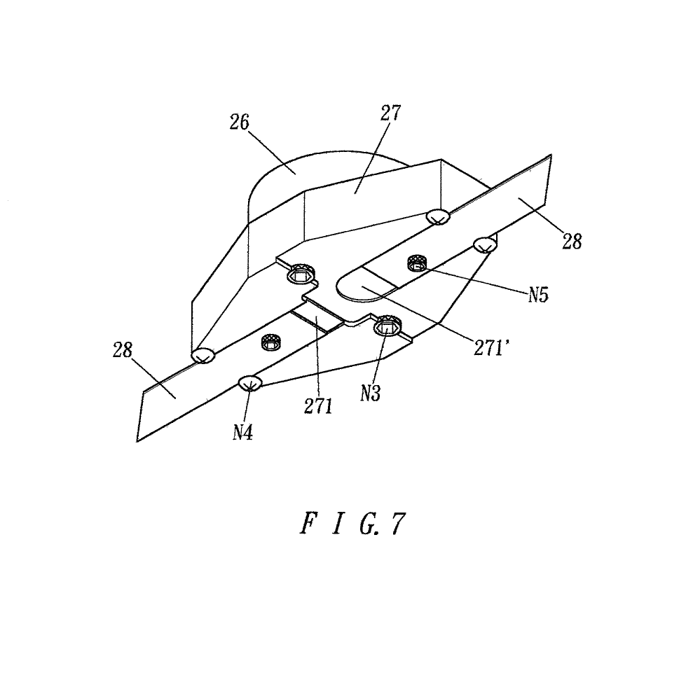

Referring to FIG. 3 for an embodiment of this invention, the cutter set includes a central strut 10 surrounding by two stationary frames 11 and 12. In the frames 11 and 12, there are disposed a plurality of cutter sets 2 and 2′ in an annular and equally spaced fashion. The cutter set 2 and 2′ have respectively an upper end engaged with a transmission disk 3 which has a plurality of bores 30. One cutter set 2′ engages with a transmission wheel 4 which is driven by a belt 5 for rotating the cutter set 2′, and subsequently drives the transmission disk 3 rotating eccentrically and driving the cutter sets 2 rotating to perform slitting operation. The cutter sets 2 and 2′ (as shown in FIGS. 4 and 5) include respectively a crank shaft 20, three sets of bearing 21, 22 and 23, a connection member 24, a cutter protractor plate 25, an anchor block 26, a cutter adjustment block 27 and two pieces of cutter 28. The crank shaft 20 has a shaft stem 200 at an upper portion in an eccentric manner. The shaft stem 200 has an annular groove 201. At the bottom end of the crank shaft 20, there is a cavity 202 with a screw bore 203 formed inside the crank shaft 20. The bearing 21 is mounted on the shaft stem 200 and is fastened to the shaft stem 200 securely by means of a C type snap ring 210 engaged to the annular groove 201. The perimeter surface of the bearing 21 has two annular grooves 211 engaged respectively with a snap ring 212 for holding the bearing 21 in the bore 30 of the transmission disk 3. The bearings 22 and 23 are mounted on the crank shaft 20 and being held in the frames 11 and 12. The connection member 24 is fastened to a lower end of the crank shaft 20 through a screw N. The connection member 24 has a bulged stub 241 at the upper side to engage with the cavity 202 of the crank shaft 20 and a protrusive ring 241 at a lower side with a sinking bore 242 formed therein for the screw N to pass through. The connection member 24 further has two screw bores 243 at the bottom side for engaging with screws N1 to fasten the cutter protractor plate 25 through two sinking bores 251 located at two sides of a through opening 250 formed at the center of the cutter protractor plate 25. The cutter protractor plate 25 has same number of protracting screw bores 252 as the cutter sets 2 and 2′ for adjusting the mounting angle of the cutter 28. The anchor block 26 is fastened to the cutter protractor plate 25 through screws N2 at selected screw bores 252 according to the desired adjusting angle of the cutter 28. The anchor block 26 has a recess 260 at an upper section for holding the cutter protractor plate 25 and a trough 261 at a lower section with two screw bores 262 formed therein, and two screw bores 263 formed at the bottom thereof at two opposite sides. The cutter adjustment block 27 has two screw bores 270 formed at the bottom side to engage with the screw bores 263 through screws N3 for fastening the cutter adjustment block 27 to the lower end of the anchor block 26. The cutter adjustment block 27 further has two opposite troughs 271 and 271′ at the lower section formed in a stepwise manner. There are screw bores 272 formed respectively at the front end at two sides of the troughs 271 and 271′. In the troughs 271 and 271′, there are a plurality of fastening apertures 273. The cutter 28 has fastening apertures 280 engageable with the fastening apertures 273 through screws N5 for fastening the cutter 28 to the troughs 271 and 271′. And through flat screws N4 engaging with the screw bores 272, the cutter 28 may be positioned by means of the circumference of the flat screws N4. Each cutter set 2 is constructed by means of aforesaid structure (as shown in FIGS. 6 and 7). Then the cutter sets 2 and 2′ may be mounted on the frame 11 and 12 with the cutter 28 pointing toward the annular groove 100 of the strut 10. The crank shaft 20 of one cutter set 2′ (shown in FIG. 5) engages firmly with the transmission wheel 4 through a key 40 held in a key way 204 formed on the crank shaft 20. Hence the transmission wheel 4 and belt 5 can drive the cutter set 2′ rotating.

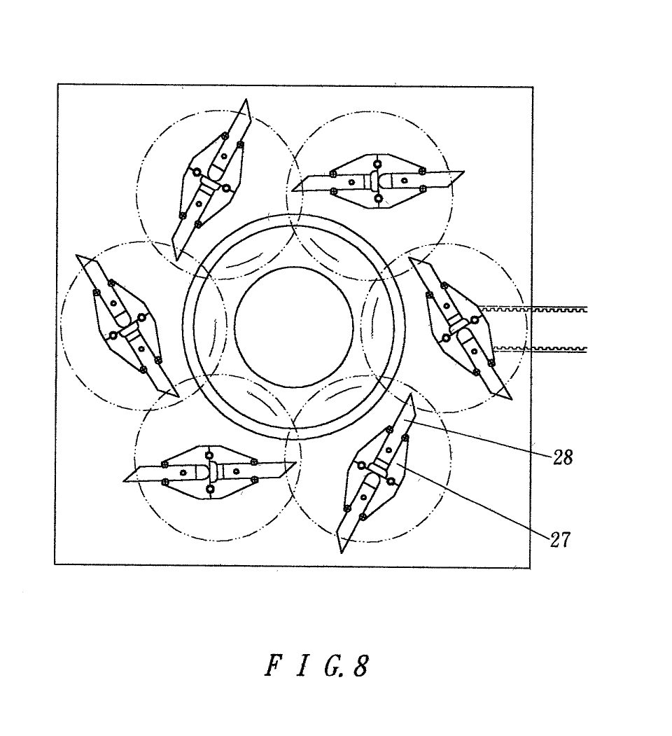

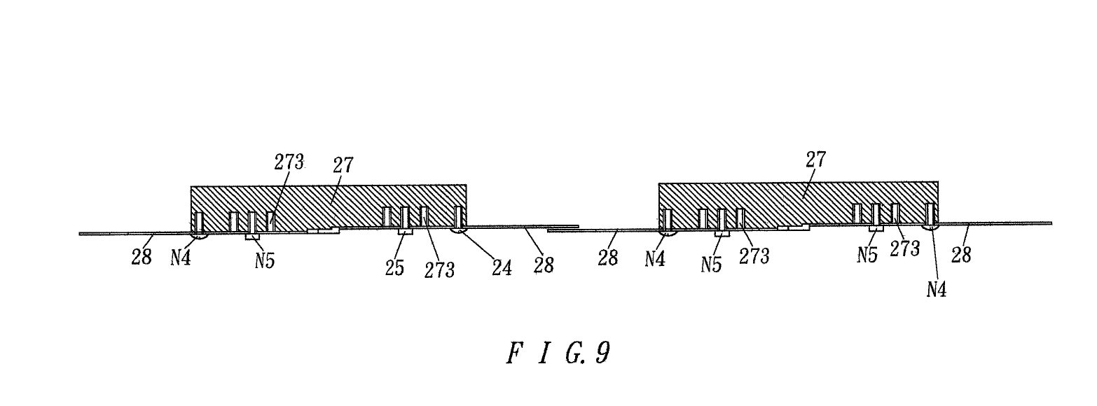

When the belt 5 drives the transmission wheel 4 rotating, the crank shaft 20 of the cutter set 2′ is driven and rotated, and also drives the cutter set 2′ rotating. Through the eccentric shaft stem 200 and transmission disk 3 (by crank shaft transmission principle), the cutter sets 2 and 2′ will rotate synchronously to perform slitting operation on the shrink film sleeve (as shown in FIG. 8). As each cutter set 2 has two sets of cutter 28 in opposite direction, the cutting displacement may be shortened and slitting of the film sleeve will be done synchronously. As a result, the slit opening is neat and even, and the cutting speed is fast and steady. Furthermore, as two sets of the cutter 28 are mounted at different step levels rather than at the same plane (shown in FIG. 9), the cutters 28 won't hit against each other. When replacing the cutter 28 is desired, it may be done simply by loosening the flat screws N4 and fastening screws N5. When there is a need to adjust the length of the cutter 28, fasten the screw N5 through the fastening apertures 280 of the cutter 28, and engage the screw N5 in different apertures 273 of the troughs 271 and 271′. It may be done conveniently and rapidly, and save adjusting time.

While the preferred embodiment of the invention has been set forth for purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An improved cutter set for heat shrink film sleeve labeling machine comprising a strut surrounded by stationary frames which have a plurality of cutter sets located thereon, one cutter set being engaged with a transmission wheel, each cutter set including a crank shaft, a plurality of bearings mounting on the crank shaft, a connection member, a cutter protractor plate, an anchor block, a cutter adjustment block and two pieces of cutter, the crank shaft having an eccentric shaft stem at one end thereof for engaging with a transmission disk, the connection member being fastened to a lower end of the crank shaft through a screw, the cutter protractor plate being fastened to a lower end of the connection member and having a plurality of protracting screw bores for adjusting mounting angle of the cutter, the anchor block being fastened to the protracting screw bores through screws according to mounting angle desired for the cutter;
wherein the cutter adjustment block has two screw bores formed at the bottom side thereof and two opposite troughs formed at a lower section in a stepwise manner, the troughs having respectively a plurality of fastening apertures and fastening respectively the cutter, and a plurality of screw bores formed respectively at a front end at two sides of the troughs.
